(19) United States
(12) Patent Application Publication
(10) Pub. No.: US 2013/0290094 A1
(43) Pub. Date: Oct. 31, 2013

(54) METHODS AND SYSTEMS TO EXPLICITLY AND IMPLICITLY MEASURE MEDIA IMPACT

(71) Applicants: Seema Varma Srivastava, Sunnyvale, CA (US); Albert Ronald Perez, San Francisco, CA (US); Antonia Toupet, Sunnyvale, CA (US); Robert T. Knight, Berkeley, CA (US); Ramachandran Gurumoorthy, Berkeley, CA (US); Avgusta Shestyuk, Berkeley, CA (US)

(72) Inventors: Seema Varma Srivastava, Sunnyvale, CA (US); Albert Ronald Perez, San Francisco, CA (US); Antonia Toupet, Sunnyvale, CA (US); Robert T. Knight, Berkeley, CA (US); Ramachandran Gurumoorthy, Berkeley, CA (US); Avgusta Shestyuk, Berkeley, CA (US)

(21) Appl. No.: 13/724,609

(22) Filed: Dec. 21, 2012

Related U.S. Application Data
(60) Provisional application No. 61/638,211, filed on Apr. 25, 2012.

(51) Int. Cl. G06Q 30/02

(52) U.S. Cl. CPC G06Q 30/0245
USPC 705/14.44

(57) ABSTRACT

Example methods, apparatus, systems, and articles of manufacture to explicitly and implicitly measure media impact are disclosed. An example method includes analyzing first survey response data obtained from a control group panelist responding to a first survey instrument after exposure to first media. An example first survey instrument includes an implicit measure. The example first survey response data includes first implicit response data. The example method further includes analyzing second survey response data obtained from a test group panelist responding to the first survey instrument after exposure to second media. The example second survey response data includes second implicit response data. The example second media includes elements of the first media and target advertising or entertainment material not included in the first media. The example method also includes assessing an effectiveness of the target advertising or entertainment material based on the first and second implicit response data.

### RELATED APPLICATION

This patent claims the benefit of U.S. Provisional Patent Application Ser. No. 61/638,211, entitled “Methods and Systems to Explicitly and Implicitly Measure Media Impact,” which was filed on Apr. 25, 2012, and which is incorporated herein by reference in its entirety.

### FIELD OF THE DISCLOSURE

This disclosure relates generally to audience measurement, and, more particularly, to methods and system to explicitly and implicitly measure media impact.

### BACKGROUND

Traditional systems and methods for assessing the impact and/or effectiveness of media (e.g., advertising, content, entertainment materials, movies, newspapers, magazines, radio, Internet websites, etc.), and/or advertising components (e.g., branding, product packaging, and/or other characteristics of products or service) often rely on surveys that are subject to noise, biases, and statistically insignificant results due to respondents' faulty memories.

### BRIEF DESCRIPTION OF THE DRAWINGS

FIG. 1 is a diagram illustrating example metrics of an example advertising effectiveness and purchasing model constructed in accordance with the teachings of this disclosure.

FIG. 2 illustrates an example system 200 constructed in accordance with the teachings of this disclosure to assess the impact of media based on one or more of the effectiveness metrics of FIG. 1.

FIGS. 3A-C, 4 and 5 illustrate example survey instruments to measure the effectiveness metrics of FIG. 1.

FIG. 6 is a schematic illustration of an example apparatus constructed in accordance with the teachings of this disclosure to measure the explicit and implicit impact and/or effectiveness of media in the example system of FIG. 2.

FIG. 7 is a flowchart representative of example machine readable instructions which may be executed to gather the survey response data and the correlate measurement data in the example system of FIG. 2 and/or to implement the example apparatus of FIG. 6.

FIGS. 8A and 8B are a flowchart representative of example machine readable instructions which may be executed to assess an effectiveness or impact of media in the example system of FIG. 2, and/or to implement the example apparatus of FIG. 6.

FIG. 9 is a schematic illustration of an example processor system that may be used and/or programmed to execute the example instructions of FIGS. 7, and/or 8A and 8B to implement the example system of FIG. 2 and/or the apparatus of FIG. 6.

### DETAILED DESCRIPTION

Known assessments of the impact and/or effectiveness of audience exposure to various subjects of interest including media (e.g., advertising, entertainment, content, etc.) and/or advertising components (e.g., trade dress, branding, logos, packaging, and/or a product itself), often rely on survey data collected from panelist(s) exposed to the media and/or advertising components. For example, the panelist(s) exposed to the media may be asked to complete surveys after exposure to determine the effect of the exposure. However, these surveys that try to measure advertising effectiveness suffer from excessive noise, statistically insignificant results, low response rates, and/or overall difficulty in isolating the impact of the exposure.

Psychological methodologies may be used to measure and/or predict the attitudes and/or behavior of individuals based on explicit and/or implicit cognitive measures. Explicit cognition refers to the conscious, volitional, and/or intentional mental processes of individuals in recalling information (memory) and making decisions based on opinions, perceptions, and/or interests (attitude). Both the explicit memory and the explicit attitudes of individuals influence their behavior. In contrast, implicit cognition refers to the unconscious, involuntary, and/or automatic mental processes associated with memory, attitude, and/or perception that influence the behavior of individuals. In other words, while people have different knowledge, perceptions, and/or memories that influence their actions, only when people are aware of, or can consciously recall, the knowledge, perception, and/or memory, is that influence explicit. Otherwise, the influence of the knowledge, perception, and/or memory of individuals is implicit. Accordingly, implicit psychological measures include tools that indirectly assess the non-declarative information processing and responses (e.g., information that cannot be provided through written or oral responses (which require explicit cognition)) of panelist(s) to particular stimuli or media. Such responses are herein referred to as ‘implicit responses’ and/or ‘automatic responses’. Furthermore, the underlying behavior or attitude of panelist(s) that may be assessed based on collected implicit responses is herein referred to as their ‘implicit attitude’, and/or ‘automatic attitude’. In contrast, panelist responses that are explicit are herein referred to as ‘explicit responses’ and/or ‘voluntary responses’.

Example methods, apparatus, systems, and articles of manufacture to explicitly and implicitly measure media and/or advertisement component impact are disclosed. Some example methods include analyzing first survey response data obtained from a control group panelist responding to a first survey instrument after exposure to first media. The example first survey instrument includes an implicit measure. The example first survey response data includes first implicit response data. Some example methods further include analyzing second survey response data obtained from a test group panelist responding to the first survey instrument after exposure to second media. The example second survey response data includes second implicit response data. In some examples, the example second media includes elements of the first media and target advertising or entertainment material which were not included in the first media. Some example methods also include assessing an effectiveness of the target advertising or entertainment material based on the first and second implicit response data. Some example methods operate similarly to those described above, but operate on advertising components which are not media (e.g., a physical product) instead of, or in addition to, media.

In some examples, the test group panelist and the control group panelist respond to a first implicit measure at a first time period and a second implicit measure at a second time period different than the first time period. In some examples, the first and second implicit measures are associated with different media effectiveness metrics.

In some examples, the implicit measure comprises an implicit association test. In some such examples, a first complementary pair of categories associated with the implicit association test comprises a first category associated with a first product or brand and a second category associated with a competing product or brand. In some such examples, the first product or brand is related to the target advertising or entertainment material.

In some examples, the implicit measure comprises a go-no-go association test as described more fully below. In some such examples, a first category in a complementary pair associated with the go-no-go association test corresponds to a first product or brand and a second category in the complementary pair is associated with a competing product or brand. The first product or brand is related to the target advertising or entertainment material.

In some examples, the implicit measure comprises a sorting test. In some such examples, the sorting test comprises a plurality of items to sort. The plurality of items includes a first item associated with the target advertising or entertainment material. In such examples, the plurality of items includes at least one of a picture, a word, or a logo. In some examples, the sorting test comprises the test group panelist and the control group panelist sorting the plurality of items based on at least one of preference or recognition.

In some examples, the implicit measure comprises a word completion test. In some examples, the word completion test requests a panelist to fill in at least one missing letter or missing word related to at least one of a target word or phrase associated with the target advertising or entertainment material or a distracter word or phrase unrelated to the target advertising or entertainment material.

In some examples, the implicit measure comprises priming as described more fully below. In some such examples, a priming comprises exposing a control group panelist and a test group panelist to a primer associated with the target advertising or entertainment material before the control group panelist and the test group panelist are to respond to a second survey instrument. In some such examples, the second survey instrument comprises a survey question associated with the target advertising or entertainment material.

In some examples, the first survey instrument is in a game format. In some such examples, the game format comprises at least one of timing a response to the first survey instrument, awarding a point for a completed response, awarding a point for a correct response, deducting a point for an incorrect response, or awarding a point if a speed of response is beneath a threshold.

Some example methods further include analyzing correlate measurement data gathered from the test group panelist. Some such example methods also include validating the media effectiveness metric based on the correlate measurement data. In some such examples, the correlate measurement data includes at least one of eye-tracking data, neuro-physiological data, or purchase behavior data of the test group panelist. In some examples, the neuro-physiological data includes electroencephalographic data.

Some example methods further include analyzing third survey response data obtained from a second control group panelist responding to a second survey instrument after exposure to first media (and/or non-media advertising components) and analyzing fourth survey response data obtained from a second test group panelist responding to the second survey instrument after exposure to second media (and/or non-media advertising components). Some such example methods also include assessing a second effectiveness of the target advertising or entertainment material based on the third survey response data and the fourth survey response data.

In some such examples, the second survey instrument comprises at least one test alternative that is different than the first survey instrument, the at least one test alternative comprising at least one of a type of survey instrument, a latency period, a survey instrument format, a wording of instructions or a question, or a type of effectiveness metric to be assessed.

Some such example methods also include calculating at least one of a first accuracy, a first reliability, or a first significance of the effectiveness of the target advertising or entertainment material based on first purchase behavior data corresponding to actual purchases by the control group panelists and/or the test group panelist. Some such example methods also include calculating at least one of a second accuracy, a second reliability, or a second significance of the second effectiveness of the target advertising or entertainment material based on second purchase behavior data corresponding to actual purchases by the second control group panelists and/or the second test group panelist. Further, some such example methods include comparing at least one of the first accuracy, the first reliability, or the first significance with at least one of the second accuracy, the second reliability, or the second significance to identify preferred (e.g., an optimal) test alternative corresponding to one of the first survey instrument or the second survey instrument as yielding increased valid results.

Tangible machine readable storage mediums are disclosed herein which have instructions, which when executed cause a machine to at least analyze first survey response data obtained from a control group panelist responding to a first survey instrument after exposure to first media (and/or non-media advertising components). The example first survey instrument of some examples includes an implicit measure. The first survey response data of some examples comprises first implicit response data. In some examples, the instructions further cause the machine to analyze second survey response data obtained from a test group panelist responding to the first survey instrument after exposure to second media. The example second survey response data of some examples includes second implicit response data. In some examples, the example second includes elements of the first media and further includes target advertising or entertainment material not included in the first media. The instructions of some examples also cause the machine to assess an effectiveness of the target advertising or entertainment material based on the first and second implicit response data. Some example instructions operate similarly to those described above, but operate on advertising components which are not media (e.g., a physical product) instead of, or in addition to, media.

In some examples, the instructions further cause the machine to analyze correlate measurement data gathered from the test group panelist. In some examples, the instructions also cause the machine to validate the media effectiveness metric based on the correlate measurement data. In some such examples, the correlate measurement data includes at least one of eye-tracking data, neuro-physiological data, or purchase behavior data of the test group panelist. In some examples, the neuro-physiological data includes electroencephalographic data.

In some examples, the instructions further cause the machine to analyze third survey response data obtained from a second control group panelist responding to a second survey instrument after exposure to first media (and/or advertising components) and analyzing fourth survey response data obtained from a second test group panelist responding to the second survey instrument after exposure to the second media (and/or advertising components). In some examples, the instructions further cause the machine to assess a second effectiveness of the target advertising or entertainment material based on the third survey response data and the fourth survey response data. In some such examples, the instructions further cause the machine to calculate at least one of a first accuracy, a first reliability, or a first significance of the effectiveness of the target advertising or entertainment material based on first purchase behavior data corresponding to actual purchases by the control group panelists and/or the test group panelist. In some such examples, the instructions further cause the machine to calculate at least one of a second accuracy, a second reliability, or a second significance of the second effectiveness of the target advertising or entertainment material based on second purchase behavior data corresponding to actual purchases by the second control group panelists and/or the second test group panelist. In some examples, the instructions further cause the machine to compare at least one of the first accuracy, the first reliability, or the first significance with at least one of the second accuracy, the second reliability, or the second significance to identify a preferred (e.g., an optimal) test alternative corresponding to one of the first survey instrument or the second survey instrument as yielding increased valid results.

Apparatus are disclosed herein that include a survey response analyzer to analyze first survey response data obtained from a control group panelist responding to a first survey instrument after exposure to first media (and/or non-media advertising component). The example first survey instrument of some examples includes an implicit measure. The example first survey response data of some examples includes first implicit response data. In some examples, the example survey response analyzer also is to analyze second survey response data obtained from a test group panelist responding to the first survey instrument after exposure to second media. The example second survey response data of some examples includes second implicit response data. In some examples, the example second media includes elements of the first media and target advertising or entertainment material not included in the first media. In some examples, the example apparatus also includes an effectiveness calculator to assess an effectiveness of the target advertising or entertainment material based on the first and second implicit response data. Some example apparatus function similarly to those described above, but with respect to advertising components which are not media (e.g., a physical product) instead of, or in addition to, media.

In some examples, the apparatus further includes a correlate measurement analyzer to analyze correlate measurement data gathered from the test group panelist. In examples, the apparatus also includes an effectiveness validator to validate the media effectiveness metric based on the correlate measurement data. In some examples, the correlate measurement data includes at least one of eye-tracking data, neuro-physiological data, or purchase behavior data of the test group panelist. In some examples, the neuro-physiological data includes electroencephalographic data.

In some examples, the survey response analyzer is to analyze third survey response data obtained from a second control group panelist responding to a second survey instrument after exposure to first media and to analyze fourth survey response data obtained from a second test group panelist responding to the second survey instrument after exposure to the second media. In some such examples, the effectiveness calculator is to assess a second effectiveness of the target advertising or entertainment material based on the third survey response data and the fourth survey response data. In some examples, the apparatus further includes a survey test optimizer to calculate at least one of a first accuracy, a first reliability, or a first significance of the effectiveness of the target advertising or entertainment material based on first purchase behavior data corresponding to actual purchases by the control group panelists and/or the test group panelist. In such examples, the survey test optimizer is also to calculate at least one of a second accuracy, a second reliability, or a second significance of the second effectiveness of the target advertising or entertainment material based on second purchase behavior data corresponding to actual purchases by the second control group panelists and/or the second test group panelist. In some such examples, the survey test optimizer is further to compare at least one of the first accuracy, the first reliability, or the first significance with at least one of the second accuracy, the second reliability, or the second significance to identify a preferred (e.g., an optimal) test alternative corresponding to one of the first survey instrument or the second survey instrument as yielding increased valid results.

In some examples, the first and second implicit response data correspond to a media effectiveness metric. The media effectiveness metric of some examples is associated with a measure of at least one of an ad recall, a brand awareness, a product awareness, a brand favorability, a product favorability, a brand preference, or a product preference, a brand purchase consideration, a product purchase consideration, a brand purchase intent, a product purchase intent, a brand recommendation, a product recommendation. In some examples, the assessing the effectiveness of the target advertising or entertainment material is based on at least one of an amount of lift associated with the media effectiveness metric. In some such examples, the amount of lift corresponds to a difference between a first value of the media effectiveness metric associated with the control group panelist and a second value of the media effectiveness metric associated with the test group panelist.

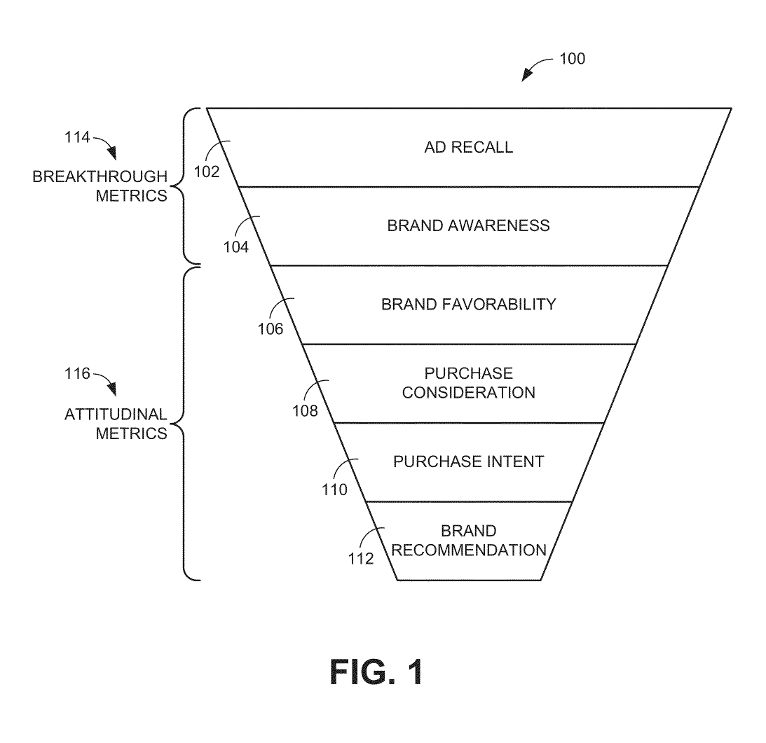

Turning to the figures, FIG. 1 is a diagram illustrating example metrics of an example advertising effectiveness and purchasing model constructed in accordance with the teachings of this disclosure. FIG. 1 illustrates an example advertising funnel 100 that conceptualizes the different types of metrics that may be used for measuring the effectiveness of media and/or non-media advertising material. Specifically, the example funnel 100 includes multiple levels or stages corresponding to different metrics associated with advertising effectiveness in a hierarchical order. In the illustrated example, these levels include ad recall 102, brand awareness 104, brand favorability 106, purchase consideration 108, purchase intent 110, and brand recommendation 112.

The ad recall metric 102 of the illustrated example is a measure of whether a person remembers seeing an advertisement or some aspect of the advertisement (e.g., the product, the brand name or logo, a particular image, etc.). The brand awareness metric 104 of the illustrated example is a measure of whether a person recognizes or is aware of a brand associated with the advertising material. Although the terms “recall” and “awareness” typically refer to the conscious recollection of information (i.e., explicit memory), as used herein, the terms “recall” and “awareness” apply to both explicit memory and/or implicit memory. The brand favorability metric 106 of the illustrated example is a measure of whether a person's opinion of a brand is favorable (e.g., whether the person likes the brand). In some examples, brand preference may be measured in addition to, or in place of, brand favorability. Brand preference refers to a person's preference of a brand over a competing brand (e.g., whether the person likes brand A more than brand B) regardless of what the person's favorability of either brand may be in an absolute sense. The purchase consideration metric 108 of the illustrated example is a measure of the degree to which a person contemplates or considers making a purchase of a product or service associated with the advertised brand after being exposed to the advertising material. The purchase intent metric 110 of the illustrated example is a measure of whether a person actually intends to make a purchase as a result of exposure to the advertising material. The brand recommendation metric 112 of the illustrated example is a measure of whether a person would recommend a brand to someone else.

The ad recall metric 102 is at the top level of the hierarchy in the example funnel 100 of FIG. 1 because it is a prerequisite of the lower-level metrics. In a similar manner, each successive level down the example funnel 100 is a prerequisite to the next metric. For example, people first recall an advertisement before they become aware of a brand associated with the advertisement; people are aware of the brand before they will favor the brand; and so forth. Additionally, the example funnel 100 is widest at the top level (e.g., ad recall) and narrows towards the bottom because the amount or degree of impact of media on each of the effectiveness metrics 102, 104, 106, 108, 110, 112 (sometimes referred to as ‘lift’) resulting from exposure to the media is greatest for ad recall 102 and is expected to diminish to some degree (but not necessarily linearly) for each successive metric lower down the funnel 100.

Furthermore, as shown in FIG. 1, the metrics of the example funnel 100 are broken into two general categories or types of metrics: (1) breakthrough metrics 114, and (2) attitudinal metrics 116. In market research, breakthrough metrics 114 correspond to whether exposure to advertising material can “breakthrough” all the stimuli people are exposed to each day to leave an impression. Thus, breakthrough metrics 114 are associated with the memory of a person (e.g., whether something resonates with the person and the person remembers it). Attitudinal metrics 116 correspond to whether advertising material can impact the opinions and/or attitudes of people towards a brand associated with the advertisement. Thus, attitudinal metrics 116 are associated with the attitudes of a person and the resulting behavior based on those attitudes.

Although the example funnel 100 of FIG. 1 has been shown and described as applying to brands, the same framework similarly applies to a particular product and/or service associated with advertising material. Additionally, the same principles of the framework apply to other forms of media besides advertisements such as movies, TV shows, music, and/or other entertainment material except that the focus is not on the recall, awareness, and/or favorability of a brand or product but on the recall, awareness, and/or favorability of a particular program, plot, character, scene, storyline, lyrics, joke, etc.

Based on the framework represented by the example funnel 100 of FIG. 1, survey instruments may be developed that include questions directed to one or more of the metrics 102, 104, 106, 108, 110, 112. As used herein, the term ‘survey instrument’ refers to any of a question, task, exercise, or other activity that elicits a response from panelist(s) engaging in the activity. Traditional survey instruments (e.g., survey questionnaires) obtain explicit survey response data in which the panelist(s) respond to questions based on that which the panelist(s) are consciously aware (i.e., the explicit cognition of the panelist(s)). As a result, such known survey instruments obtain a limited view of the entire picture of what motivates the thoughts, attitudes, and behaviors of consumers and how media (e.g., advertising or entertainment material) and/or other forms of advertisements affect those thoughts, attitudes, and behaviors because the surveys do not measure the implicit memory and/or attitudes, and resulting behavior, of consumers. Such limitations are overcome in examples disclosed herein using different surveys and/or survey-like instruments that obtain implicit responses from panelist(s). As a result, examples disclosed herein provide a greater ability to predict behavior (e.g., whether a person will buy a particular advertised product) than by using only explicit response data gathered using traditional survey instruments.

In some examples, implicit response data may be more useful than explicit response data because implicit responses provide response data that panelist(s) may be otherwise unwilling or unable to provide, such as when panelist(s) are responding to very similar or sensitive brands, products, and/or media. To obtain implicit feedback, the examples disclosed herein provide several survey instruments that involve questions, tasks and/or activities that engage the implicit memories and/or attitudes of the panelist(s). Such example survey instruments enhance market research and employ implicit measurement techniques to one or more of the metrics 102, 104, 106, 108, 110, 112 of the example funnel 100 of FIG. 1.

In addition, examples disclosed herein employ secondary or external measurements to serve as benchmarks to independently validate and/or confirm the reliability and/or accuracy of the implicit response measurements based on a degree of correlation. In some examples, these correlate measurements include eye tracking technology to determine whether a panelist actually views an object of interest (e.g., an advertisement (e.g., a banner on a webpage)). In this manner, researchers may confirm whether an indication of implicit ad recall is actually based on the exposure to the target subject of interest (e.g., an advertisement) or merely coincidental. Another example correlate measurement disclosed herein involves neurological and/or physiological measurements. In some such examples, electroencephalographic (EEG) sensors are used to measure the brain waves of panelist(s) to assess emotion, attention, and/or memory of the panelist(s) while exposed to the media and/or non-media based advertising material. Gathering such data enables mid-funnel metrics, such as brand favorability 106, to be validated and/or verified. In some examples, the correlate measurements additionally or alternatively include the actual purchase behavior of the panelist(s) and/or proxy measurements of such behavior to assess the reliability of the implicit measurements associated with the purchase consideration metric 108 and/or the purchase intent metric 110.

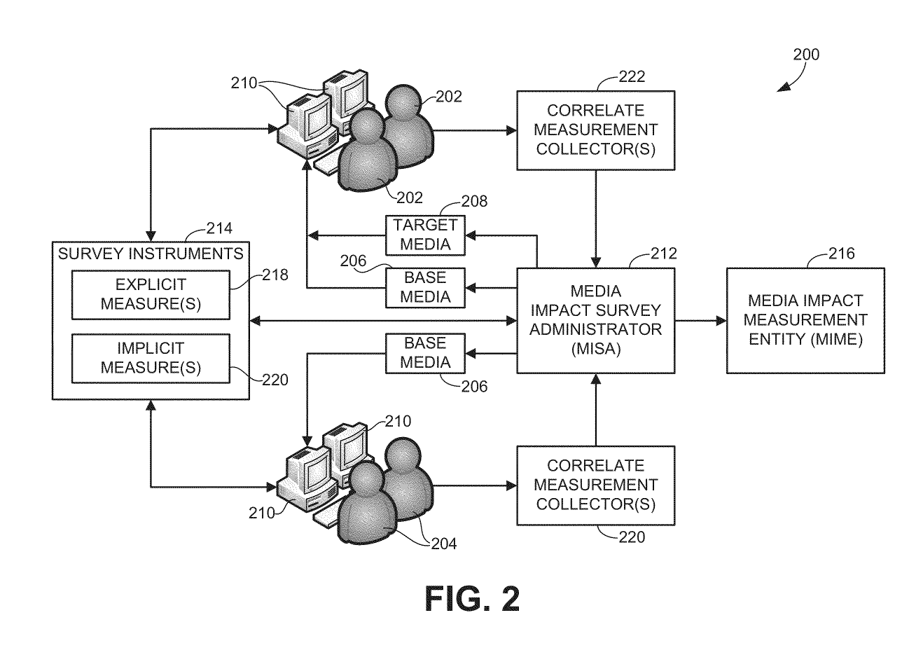

FIG. 2 illustrates an example system 200 to assess the impact of media (e.g., advertising or entertainment material) and/or non-media based advertising material based on one or more of the effectiveness metrics of FIG. 1. The example system 200 of FIG. 2 is implemented by surveying panelists 202, 204 after the panelists 202, 204 have been exposed to the media and/or non-media based advertising components and/or material. In the illustrated example, the panelists 202, 204 are randomly assigned to be either a test group (target group) panelist 202 or a control group panelist 204. In some examples, both the test group and control group panelists 202, 204 are exposed to base media and/or non-media advertising material 206. In addition to the base media and/or non-media advertising material 206, the test group panelists 202 of the illustrated example are also exposed to target media and/or non-media advertising material 208 corresponding to the material to be assessed for effectiveness. The target media and/or non-media advertising material 208 may be an advertisement, a television program, a movie, a radio show, a physical product, etc. In contrast, the control group panelists 204 are not exposed to the target media and/or non-media advertising material 208. In some such examples, all the panelists 202, 204 are exposed to the base media and/or non-media advertising material 206 to provide a common or baseline environment in which to assess the impact of the target media and/or non-media advertising material 208. For example, because all of the panelists 202, 204 are exposed to the same base media and/or non-media advertising material 206 environment, any differences in feedback from the test group panelists 202 relative to the feedback from the control group panelists 204 is assumed to be attributable to the target media 208.

In some examples, the test group panelists 202 are exposed to base media and/or non-media advertising material 206 that is identical to the base media 206 to which the control group panelists 204 are exposed. For example, both the test group panelists 202 and the control group panelists 204 may be exposed to the same television program with the target media 208 inserted during a commercial break for the test group panelists 202. However, in other examples, the base media and/or non-media advertising material 206 is not necessarily identical between the test group panelists 202 and the control group panelists 204 other than the general environment of the base media and/or non-media advertising material 206. For example, the base media 206 may be a news information website (e.g., cnn.com, nytimes.com, etc.) that the panelists 202, 204 are free to browse and the target media 208 may be an internet banner advertisement that is embedded in one or more web pages visited by the test group panelists 202 while they browse. In the illustrated example, both the test group panelists 202 and the control group panelists 204 are exposed to the base media and/or non-media advertising material 206 and/or the target media and/or non-media advertising material 208 via any number and/or type(s) of media presentation devices 210 including televisions, computers, smart phones, tablets, radios, etc.

In some examples, a media impact survey administrator (MISA) 212 provides the base media 206 to the panelists 202, 204 as well as the target media 208 to the test group panelists 202 for viewing via the media presentation devices 210. In some examples, the MISA 212 provides the base media 206 and the target media 208 via the Internet accessible to the panelists 202, 204 in any environment such as, for example, in the panelists' homes (which may serve as a virtual laboratory). In some such examples, the media presentation devices 210 are associated with specific software and/or hardware to enable the MISA 212 to monitor and/or control the exposure of the panelists 202, 204 to the media 206, 208. In other such examples, the media presentation devices 210 do not include any special software and/or equipment, and the panelists 202, 204 access the media 206, 208 on a web page administered by the MISA 212. In other examples, the example system 200 is implemented in a closed system environment (e.g., in a laboratory setting) that does not require a connection to the Internet. Also, in some examples, the MISA 212 provides the base media 206 and the target media 208 via a communication link such as, for example, a cable connection, a satellite transmission, a local area network, a radio transmission and/or any other suitable communication link.

During and/or after the test group panelists 202 have been exposed to the base media 206 along with the target media 208 and the control group panelists 204 have been exposed to the base media 206, the MISA 212 provides one or more survey instruments 214 to be completed by the panelists 202, 204. In some examples, the survey instruments 214 are provided to the panelists 202, 204 during and/or immediately following exposure to the base media 206 (and target media 208 for the test group panelists 202). In other examples, there is a latency period between the time when the panelists 202, 204 are exposed to the media and when the panelists participate in the survey instruments 214. In some examples, the latency period is up to 24 hours or more after exposure to the media 206, 208 including, for example, two days, a week, a month and/or any other suitable time period. In some examples, the latency period can affect the responses provided by the panelists 202, 204. For example, the panelists 202, 204 may be able to explicitly (i.e., consciously) recall the media the panelists were exposed to immediately following the exposure but forget the media over time. However, the panelists 202, 204 may retain the media the panelists were exposed to in implicit (unconscious) memory for a longer time period and/or recall of the media may improve in implicit memory over time if the memory is reinforced (e.g., via priming, as disclosed herein).

Furthermore, the affect of time on the explicit and implicit attitude of the panelists 202, 204 may or may not be linked to the panelists' explicit and implicit memory. Accordingly, in some examples, the panelists 202, 204 may respond to a first survey instrument after a first latency period and a second survey instrument (of the same or different type) after a second latency period different than the first latency period. Furthermore, in such examples, the first and second survey instruments may be directed to the same effectiveness metric or different effectiveness metrics as disclosed above in connection with FIG. 1. For example, a survey question (e.g., an explicit measure) directed to ad recall may be posed of the panelists 202, 204 immediately following exposure to the media and an implicit association test (IAT) directed to product favorability (e.g., an implicit measure disclosed in greater detail below) administered to the panelists 202, 204 after a 24-hour latency period. By varying the latency period for the survey instruments 214, the different effects of time on the different aspects of the impact or effectiveness of the target media 208 may be determined and/or accounted for.

As shown in the illustrated example, the panelists 202, 204 are provided the survey instruments 214 via the media presentation devices 210 through which the panelists 202, 204 were exposed to the media 206, 208. In other examples, the survey instruments 214 are provided to the panelists 202, 204 through a different media presentation device 210 and/or any different medium. In some examples, the survey response data gathered from the panelists 202, 204 is provided to a media impact measurement entity (MIME) 216 for analysis as is disclosed in greater detail below. In some examples, the MISA 212 and the MIME 216 are the same entity, include the same processor and/or are components in the same computing device.

In the illustrated example, the survey instruments 214 include one or more explicit measure(s) 218 and one or more implicit measure(s) 220. Thus, whereas ‘survey instrument’ is used herein to generically refer to any type of question, task, and/or activity engaged in by panelist(s) to elicit the panelists' responses, ‘survey measures’ (e.g., explicit measures or explicit measures) refer to particular types of survey instruments. For example, the explicit measure(s) 218 include any type of survey and/or survey-like method of obtaining self-reported and/or declarative information (i.e., information a panelist may provide through a written or oral response) such as a multiple choice question, a fill in the blank question, a short answer question, a diary, and/or any other suitable instrument to obtain explicit response data. The implicit measure(s) 220 of the illustrated example include survey and/or survey-like instruments that involve questions, tasks and/or activities that, when responded to and/or engaged in, call upon the implicit memories, attitudes, and/or perceptions of the panelists 202, 204. Some example survey instruments involving implicit measures 220 include an implicit association task or test (IAT), a go-no-go association task or test (GNAT), a word completion test, a sorting test, and/or priming. In the illustrated example, the MISA 212 may provide correlate measurement data based on feedback from the panelists 202, 204 obtained via the correlate measurement collector(s) 222 to the MIME 216 for analysis in connection with the survey response data described above.

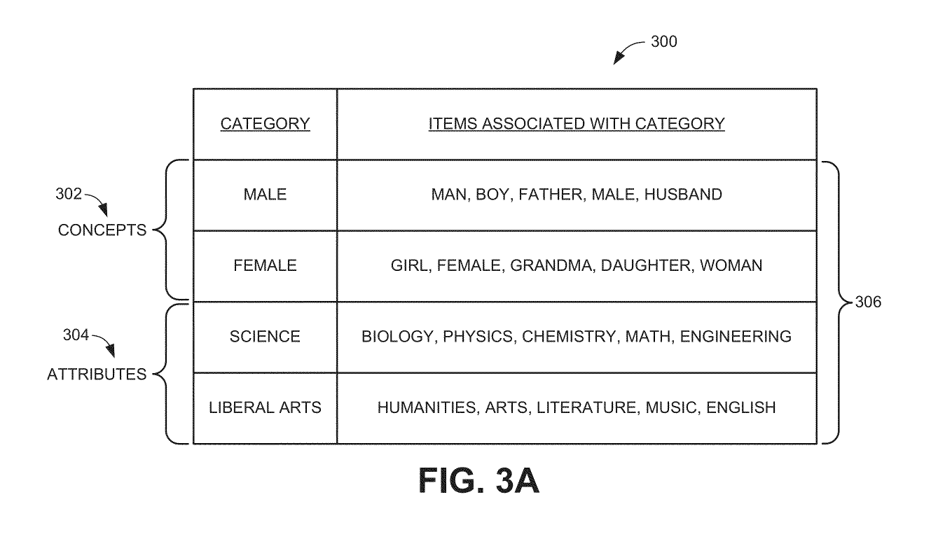

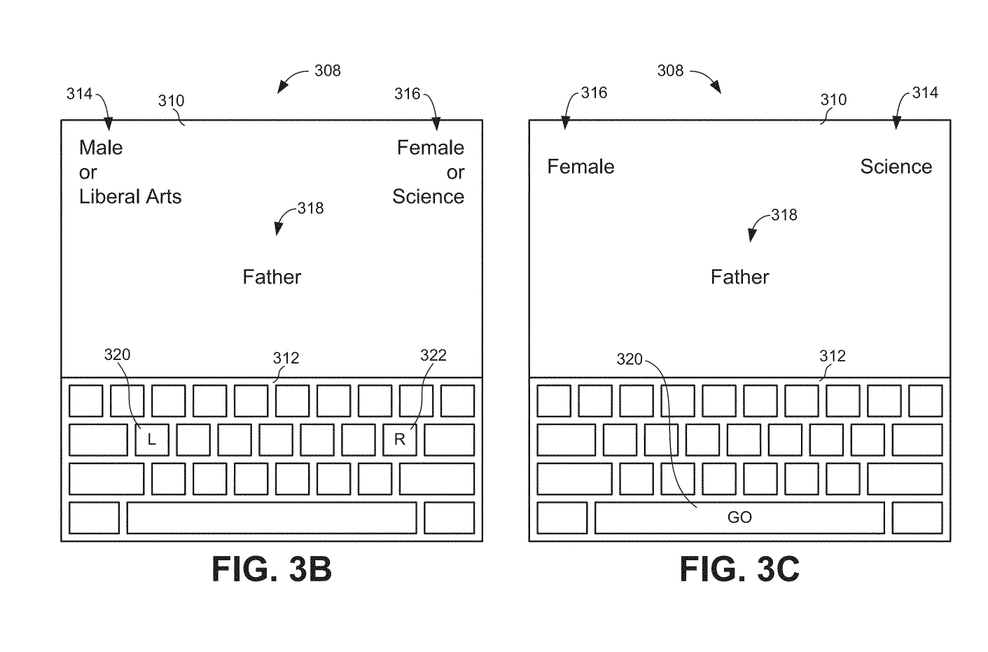

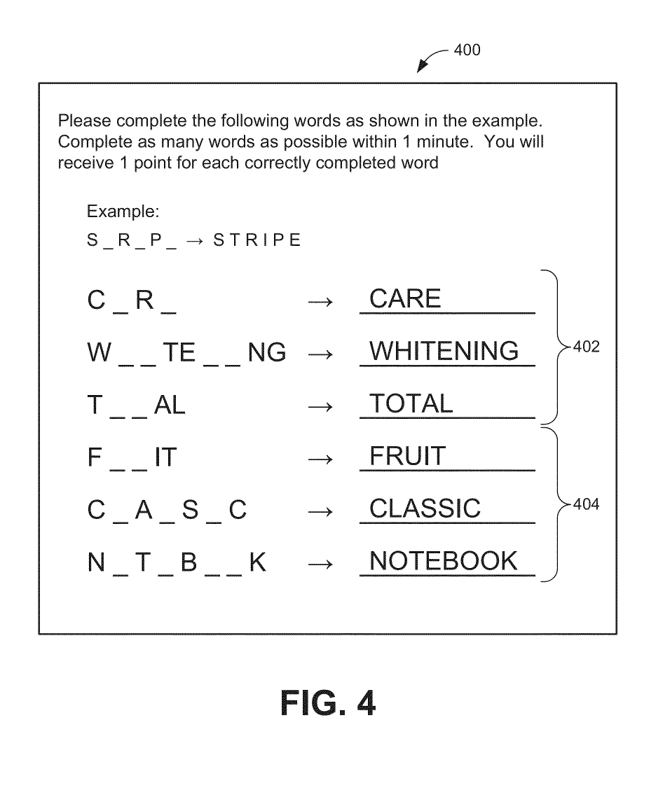

An example survey instrument, an IAT, described in connection with FIGS. 3A and 3B, is an implicit measure used to detect a person's automatic association (i.e., based on implicit cognition) of two concepts forming a first complementary pair of concepts with two attributes forming a second complementary pair of attributes. The attributes correspond to any defining quality and/or characteristic that may be applied to either of the concepts in the first complementary pair of concepts. The pairs of concepts and pairs of attributes are complementary in that each concept or attribute can be distinguished from its complement based on mutual exclusivity. For example, concepts that form a complementary pair include male and female, action and romance, and so forth. Example attributes that may form a complementary pair include good and bad, cheap and expensive, and so forth. The complementary categories (of concepts and attributes) do not necessarily have to be opposites (e.g., male/female) but merely mutually exclusive when compared with each other (e.g., car/truck, flower/bug).

Additionally, the concepts correspond to the subject matter about which the implicit attitude of a person is being tested with respect to the attributes to be applied to the concepts. For example, FIG. 3A illustrates an example table 300 of concepts 302, attributes 304 and corresponding items 306 associated with each. In the illustrated example, the complementary pair of concepts 302 may correspond to Male and Female while the complementary pair of attributes 304 corresponds to Science and Liberal Arts. Furthermore, as shown in the table 300 of FIG. 3A, in an IAT, each of the two concepts 302 and each of the two attributes 304 correspond to one of four categories of one or more items 306 representative of each respective concept or attribute. In the example table 302, the items 306 include words associated with each of the categories. In other examples, the items may include phrases, logos, pictures, etc. For example, in a market research setting, where the implicit effectiveness or impact of advertising or entertainment material on an associated brand is to be assessed, the target concept may be the brand and its corresponding category of items may include the brand name and/or the brand logo. Similarly, in such an example, a distractor concept may be a competing brand (to form a complementary pair) and its corresponding category of items may include the competing brand name and/or brand logo. Further, in such an example, the second complementary pair of attributes may correspond to a positive attribute (e.g., good) and a negative attribute (e.g., bad). The ‘good’ category of items may include, for example, the words happy, joyful, pleased, celebrating, and glee. The ‘bad’ category of items may include, for example, the words awful, terrible, nasty, dislike, and noxious.

In some examples, a first concept in the first complementary pair of an IAT corresponds to a target concept while the complementary concept in the pair corresponds to a distractor concept. The target concept is associated with the concept for which the implicit attitudes of the panelists 202, 204 are being tested. In contrast, the distractor concept is associated with some other concept. In some examples disclosed herein, the distractor concept serves as an alternative to the target concept. For example, the first complementary pair of concepts may correspond to a product or brand associated with the advertising or entertainment material of the target media 208 (the target concept) and competing product(s) or brand(s) (the distractor concept). In other examples, the distractor concept may correspond to unrelated product(s), brand(s), or other concept(s). Although many examples disclosed herein refer to media, example methods, apparatus and articles of manufacture disclosed herein may likewise apply to non-media advertisements, such as physical products, product packaging, etc. For example, if the implicit attitudes of the panelists 202, 204 are to be assessed with respect to toothpaste, toothpaste would be the target concept in the complementary pair and vacuum cleaners could be the distractor concept in the complementary pair.

During the IAT, the panelists 202, 204 identify or associate the items from any of the four categories with one or more of the concepts or attributes. In some examples, an IAT is done via a computer 308 having a screen 310 and keyboard 312 (FIG. 3B). In some such examples, the complementary pairs of concepts 302 and/or attributes 304 are displayed in opposing left and right corners 314, 316 of the screen 310. Further, a series of the items 306 corresponding to any one of the concepts 302 and/or attributes 304 displayed on the screen 310 are provided near the middle of the screen 318. In such examples, the panelists 202, 204 are instructed to identify the category (concept or attribute) to which the displayed item 306 is associated. To do so, in some examples, the panelists 202, 204 press a left button 320 on the keyboard 312 when an item 306 displayed in the middle 318 of the screen 310 corresponds to the concept and/or attribute in the left corner 314, and press a right button 322 when the displayed item 306 corresponds to the concept and/or attribute in the right corner 314. The speed at which the panelists 202, 204 associate the concepts and attributes is an indication of the panelists' 202, 204 implicit attitudes with respect to the concepts involved. As a result, by comparing the difference in speed between the test group panelists 202 and the control group panelists 204 when the target concept is associated with the target media 208, the MIME 216 can assess the impact the target media 208 had on the implicit attitudes and/or perceptions of the test group panelists 202.

A disclosed example IAT involves four different tasks or exercises that may be repeated one or more times during a complete test procedure. A first task involves providing a successive set of items (e.g., words, phrases, logos, images, etc.) to the panelists 202, 204 some of which are from the category associated with the target concept while others are from the category associated with the distracter concept. As each item is presented to the panelists 202, 204, the panelists 202, 204 are to identify whether the displayed item is associated with the target concept or the distracter concept. In some examples, where the panelists 202, 204 participate in the IAT via a computer (whether the same or different than the media presentation devices 210), the panelists 202, 204 indicate the correct concept (e.g., target or distracter concept) by pressing a key on a computer or an area of a screen using a mouse or a finger of a panelist using a touch-screen device corresponding to each of the concepts. A second task involves a similar process of providing a successive set of items from the categories associated with the second complementary pair of attributes (e.g., ‘good’ items and ‘bad’ items), and the panelists 202, 204 are to classify each item with the corresponding attribute as the item appears. A third task in the IAT involves combining one concept (e.g., target concept) with one attribute (e.g., target brand+good) and combining the other concept (e.g., distractor concept) with another attribute (e.g., competing brand+bad). In the third task the panelists 202, 204 are provided items from any of the four categories (e.g., items associated with the target concept, distracter concept, first attribute, or the second complementary attribute). As each item appears, the panelists 202, 204 are to classify the item into the combined concept-attribute category to which the panelists 202, 204 believe the item corresponds. A fourth task in the example IAT involves cross-combining the concepts and attributes such that the first concept (e.g., target concept) is combined with the second attribute (e.g., target brand+bad) and the second concept (e.g., distractor concept) is combined with the attribute (e.g., competing brand+good). The panelists 202, 204 again classify successive items into the appropriate combined category, according to the panelists' 202, 204 opinions.

Throughout the example IAT procedure the panelists 202, 204 attempt to identify the category corresponding to each item as fast as possible and the response time or reaction time for each item is recorded. The reaction times during the first and second tasks of the IAT provide a baseline for the response sensitivity of the panelists 202, 204. From this baseline, the reaction times during the third and fourth tasks enable the MIME 216 to determine the implicit attitude of the panelists 202, 204 with respect to the tested attributes as the attributes relate to the tested concepts. Faster responses are interpreted as implicitly (e.g., unconsciously) easier associations between the concept and the attribute for the panelists 202, 204 and, therefore, suggest a stronger association in implicit cognition of the panelists 202, 204. For example, the panelists 202, 204 who are faster in classifying items associated with the target concept (e.g., a logo of the target brand) when the target concept is grouped with the positive attribute (e.g., target brand+good), indicates that the panelists 202, 204 implicitly favor the target concept (e.g., target brand) or view the target concept positively. In contrast, slower response times indicate a more difficult pairing that is interpreted as an implicit bias against the association of the concept with the attribute to which the concept is grouped.

In some examples, the association between item(s) and a corresponding category may be based more on objective facts than subjective opinion. In such examples, in addition to reaction times, the panelists 202, 204 may incorrectly identify the category associated with one or more items in any of the tasks of the IAT. Accordingly, the number of correct and incorrect responses, in conjunction with the response time for each, may be evaluated to further assess the implicit attitudes of the panelists 202, 204.

The above disclosed example manner of implementing an IAT enables a determination of the implicit attitudes and/or perceptions of the panelists 202, 204. However, in some examples, the example IAT may not directly indicate the effectiveness of the target media and/or target non-media advertising components 208 to impact the implicit attitudes and/or perceptions of the panelists 202, 204 when the implicit attitudes may have already been present prior to exposure to the target media 208. Accordingly, to assess the effectiveness of the target media 208, in some examples, the MIME 216 calculates the difference in response times between the test group panelists 202 and the control group panelists 204. For example, after performing the IAT, the MIME 216 may determine that the response times of the test group panelists 202 are faster than the response times of the control group panelists 204 when the target concept is grouped with the positive attribute. Such a determination is an indication that the target media 208 (which only the test group panelists 202 were exposed to) increased the implicit favorability of the test group panelists 202 towards the target concept and, therefore, was effective.

Another example survey instrument is the go-no-go association test (GNAT), described in connection with in FIGS. 3A and 3C. The GNAT is another example implicit measure that is an adaptation of the IAT. Like the IAT, the GNAT involves concepts, attributes and items in corresponding categories as illustrated in the example table of FIG. 3A. In the illustrated example, there are two concepts, and two attributes resulting in four corresponding categories. Other examples may include other amounts. The GNAT does not involve classifying items associated with the categories into one of two combined categories as in the IAT (e.g., target product+good and competing product+bad). Rather, the GNAT provides one combined category (concept+attribute) and then provides items from any of the four categories respectively associated with the target concept, the distractor concept, the first attribute, or the second attribute in a series of successive timed trials. For example, as shown in the example of FIG. 3C, one of the concepts 302 is displayed in the left corner 314 of the screen 310, one of the attributes is displayed in the right corner 316 of the screen 310, and individual items 306 are successively displayed in the middle 318 of the screen. In some example GNATs, where an item in a particular trial corresponds to the combined category (displayed concept+displayed attribute), the panelists 202, 204 are to perform some act (“Go”) such as pressing a button on the keyboard (e.g., the space bar 324). However, in such examples, if the displayed item does not correspond to the combined category, the panelists 202, 204 are to do nothing (“No-go”). In other examples, the panelists 202, 204 are to act (“Go”) when the presented item is unrelated to the combined category defined by the test and to do nothing (“No-go”) when the item is related to the combined category. Thus, while the IAT compares one concept to another (e.g., target brand versus competing brand), the GNAT may focus on a single concept (e.g., target concept). Furthermore, while the IAT compares one concept with a complementary concept, the GNAT can also compare the target concept with a more generic concept or context that is not necessarily complementary (i.e., not necessarily mutually exclusive). For example, whitening toothpaste may be the target concept that is compared against any type of toothpaste or any type of hygiene product, which are more generic concepts.

As disclosed above, the IAT and the GNAT are used to determine the implicit attitudes and/or perceptions of the panelists 202, 204. Thus, the IAT and the GNAT are used to assess the effectiveness of advertising or entertainment material (e.g., the target media 208) on the attitudinal metrics 116 of the example advertising funnel 100 of FIG. 1. However, some of the other implicit measures 220 are adapted to assess the effectiveness of the advertising or entertainment material associated with the breakthrough metrics 114 of the example funnel 100.

For instance, some examples disclosed herein which use the word completion test, are useful to assess the ad recall of the panelists 202, 204. An example word completion test 400 is shown in FIG. 4 and involves presenting a series of incomplete words (missing one or more letters) and the panelists 202, 204 are tasked with filling in the missing letters. In examples disclosed herein, at least some of the words are target words while others of the words are distractor words. The target words are words associated with the target media 208 and/or the subject matter of the target media 208 (e.g., corresponding product or brand) whereas the distractor words are words unrelated to the target media 208. For example, if the target media 208 associated with the example word completion test 400 was an advertisement for Brand X Total Care Whitening toothpaste, the target words 402 may include “total”, “care”, and “whitening” presented to the panelists 202, 204 as “t_{——}al”, “c_r_”, and “w_{——}te_{——}ng”, respectively. In such examples, the distracters words 404 may include “fruit”, “classic”, and “notebook” presented to the panelists 202, 204 as “f_{——}it”, “c_a_s_c”, and “n_t_b_{——}k”, respectively. The completed words are shown in the illustrated example for simplicity in explanation.

In some examples, a list of incomplete words is presented at one time and the panelists 202, 204 are asked to complete as many words as the panelists 202, 204 can within a certain timeframe (e.g., one minute). While the control group panelists 204 may be able to complete the target words without having been exposed to the target media 208, the implicit memory of the test group panelists 202 may enable the test group panelists 202 to complete the target words more easily and, therefore, complete more of the target words. The completion rates of target words as compared with the distractor words between the test group and the control group provide an indication of the impact of the target media 208 on being recalled from implicit memory.

In other examples, the panelists 202, 204 are presented one incomplete word at a time and the response time to complete each word is measured. In some examples, a faster time to complete the target words is achieved by the test group panelists 202 indicative of the test group panelists' 202 implicit memory of the target media 208. Alternatives to the word completion test disclosed above may also be implemented. For example, instead of missing letters in a word, the test may include phrases with entire words missing. Alternatively, the words and/or phrases may be scrambled and the completion test requires the panelists 202, 204 to unscramble the words and/or phrases.

Another example survey instrument is the sorting test. The sorting test is another implicit measure 220 that may be used to assess the implicit memory (to measure breakthrough metrics 114) as well as implicit attitudes or perceptions (to measure attitudinal metrics 116) of the test group panelists 202. An example sorting test 500 is shown in FIG. 5. In some examples, during and/or after being exposed to base media 206 (along with target media 208 for the test group panelists 202), the panelists 202, 204 are presented with a plurality of items 502 (e.g., words, logos, pictures, etc.) to sort, rank, or otherwise order based on the panelists' 202, 204 memory, attitudes, and/or perceptions of the items. In such examples, at least one of the items 502 is a target item 504 that is associated with the target media 208 and/or the subject matter of the target media 208. Using the example above, of an advertisement for Brand X Total Care Whitening toothpaste, in the illustrated example sorting test 500, the plurality of items 502 may be different pictures of smiling faces showing their teeth with one picture (the target item 504) showing a man having his teeth whitened. In some examples, the target item or picture is taken directly from the target media 208. In other examples, the target item 504 merely relates to the target media 208.

Once presented with the plurality of pictures, the panelists 202, 204 may be requested to order or rank the pictures according to the panelists' 202, 204 preference. The position or rank of the target picture relative to the other pictures between the test group panelists 202 and the control group panelists 204 is an indication of the implicit familiarity (memory) of the target advertisement from which the target picture was derived, and any resulting implicit favorability for the product and/or brand associated with the target media 208. In this manner, the MIME 216 may assess the effectiveness of the advertisement with respect to brand or product favorability. In another example, the panelists 202, 204 may be presented with the plurality of items and then requested to identify the item the panelists 202, 204 recognize from a recent ad the panelists 202, 204 saw while exposed to the base media 206. In such examples, the difference in how frequently the test group panelists 202 recognize the target item relative to the control group panelists 204 is used to assess the effectiveness of the target media 208 with respect to ad recall.

Another implicit measure 220 is priming. Priming involves exposing the panelists 202, 204 to an item (e.g., word, phrase, logo, image, etc.) associated with the target media 208 (e.g., screen shot of a television commercial) and/or the subject matter of the target media 208 (e.g., picture of a product in the television commercial) before the panelists 202, 204 respond to a second one of the survey instruments 214. In some examples disclosed herein, the second survey instrument is one of the implicit measures 220 described above. In other examples, the second survey instrument is an explicit measure 218, such as a survey question. In such examples, the item presented to the panelists 202, 204 before the panelists 202, 204 respond to the second survey instrument serves as a primer to trigger the memory of the test group panelists 202 regarding the target media 208 to which the test group panelists 202 were previously exposed (along with the base media 206) and to which the item relates. In such examples, the item or primer will not trigger anything in the memory of the control group panelists 204 because the item or primer would have no significance to the control group panelists 204 as the control group panelists 204 were not exposed to the target media 208 to which the item or primer relates.

Based on the priming effect of the item on the test group panelists 202, the test group panelists 202 will have increased recall of the target media 208, thereby influencing the response to the second survey instrument 214 following the priming. For example, the target media 208 may be an advertisement for Brand X Whitening toothpaste. Following exposure to the base media 206 (and the target media for the test group panelists 202), the panelists 202, 204 may be exposed to a primer (e.g., image of face having a smile with sparkling white teeth taken from the target media 208). After being primed, the panelists 202, 204 may be asked the following question: “Do you recall seeing an ad for Brand X Whitening toothpaste in the past 24 hours?” By preceding this question with exposure to a primer, the implicit memory of the test group panelists 202 is triggered, thereby increasing the test group panelists' 202 recall. However, in some such examples, the impact of the target media 208 to be registered in the implicit memory of the test group panelists 202 may be conflated by the ability of the test group panelists 202 to recall the target media 208 without the need for a primer (i.e., recall based on explicit memory). In some such examples, the test group panelists 202 are divided into a priming group and a non-priming group in which only the priming group is exposed to the primer after exposure to the base media 206 (along with the target media 208). Similarly, the control group panelists 204 are also divided into a priming group and a non-priming group in which only the priming group is exposed to the primer after exposure to the base media 206. The differences in responses from the non-priming test group panelists 202 and the non-priming control group panelists 204 will provide a measure of the explicit recall of the advertisement. The differences in responses from the priming test group panelists 202 and the priming control group panelists 204 will provide a measure of the recall of the advertisement based on explicit and implicit memory. Using these measures, the effect the advertisement has on implicit memory may be assessed by subtracting the explicit only measure from the explicit and implicit measure. In this manner, the implicit impact or effectiveness of the target media 208 may be assessed.

The above example demonstrates the implicit measure 220 of priming to determine the implicit effectiveness of an advertisement for a product (e.g., Brand X Whitening toothpaste) with respect to the ad recall metric 102 of the advertising funnel 100 described in FIG. 1. The ad recall metric 102 may alternatively be assessed with respect to a brand (e.g., Brand X) by changing the survey question to the following: “Do you recall seeing a Brand X ad in the past 24 hours?” Priming may also be used with other questions that are directed to any of the other metrics 104, 106, 108, 110, 112 of the example advertising funnel 100. For example, for the brand awareness metric 104, the survey question may be as follows: “Have you heard of Brand X?” An example question directed to the brand favorability metric 106 is: “What is your opinion of Brand X?” An example question directed to the purchase intent metric 110 is: “Next time you are in the market to buy toothpaste, how likely are you to purchase Brand X?” An example question directed to the brand recommendation metric 112 is: “How likely are you to recommend Brand X to a friend?” Other questions directed to a particular product and/or other aspect of the target media 208 in relation to any of the metrics 102, 104, 106, 108, 110, 112 may also be posed following the priming described above to assess the impact of the target media 208 on the implicit memory (e.g., breakthrough metrics) and/or the implicit attitudes and perceptions (e.g., attitudinal metrics) of the panelists 202, 204.

In addition to being able to assess the implicit memory and/or attitudes of people for a more complete assessment of the effectiveness and/or impact of advertising or entertainment material, another advantage of the implicit measures 220 disclosed herein is that the format of the implicit measures 220 is more engaging to the panelists 202, 204 than other known survey instruments 214, such as the explicit measures 218 described above. For example, many people enjoy participating in games and/or other diversions that are mentally challenging and/or help pass the time, such as online games and activities. Example implicit measures 214 disclosed herein are adapted to be in or otherwise resemble a game format to make the measures more engaging and fun for the panelists 202, 204, thereby increasing an overall response rate from all the panelists 202, 204 participating in the survey. Additionally, by making the implicit measures 214 have the appeal of a game, the panelists 202, 204 are more likely to enjoy the tasks involved without thinking about it as a survey, thereby enabling the unconscious (implicit) aspects of the panelists' memory and/or attitude to be manifest more freely without obstruction from conscious (explicit) effort.

Example implicit measures 214 disclosed herein include characteristics of games such as, for example, the timed nature of the tests (e.g., speed of response and/or set time period in which to respond) and/or the mental challenges that are involved (e.g., word completions). However, in some examples, the implicit measures 214 may also include the rewarding of points. For example, in both IATs and GNATs the panelists 202, 204 are to respond as fast as the panelists can, which may result in errors at times. Accordingly, in some examples, the panelists 202, 204 may accumulate one point for each correct response. In this manner, the panelists 202, 204 become more engaged in the test with an automatic reinforcement that encourages the panelists 202, 204 to continue participating. Additionally or alternatively, five points (or any other suitable number) may be rewarded for classifying an entire set of items within a certain time period. Using both of these pointing schemes together balances the incentives for the panelists 202, 204 to categorize the items both quickly and correctly. In a similar manner, points may be awarded for the number of completed words in the word completion test and/or the speed at which the words are completed. Likewise, points may be rewarded for correctly identified target items in a sorting test. In some examples, points may be deducted for each incorrect response.

The example system 200 of FIG. 2, also includes the correlate measurement collector(s) 222 to obtain independent or secondary correlate measurements to be used to confirm and/or validate an impact of advertising or entertainment material (e.g., the target media 208) calculated based on the implicit response data relative to any one of the effectiveness metrics 102, 104, 106, 108, 110, 112. In some examples, the correlate measurement collector(s) 222 include eye-tracking technology to track what the panelists 202, 204 actually view. For example, if the base media 206 is an online news website and the target media 208 is a banner advertisement, eye tracking can verify whether the test group panelists 202 actually looked at the banner (the target media 208) and/or the duration for which the test group panelists 202 looked at the banner (the target media 208). Such data may be used as a correlate for an ad recall metrics 102 (e.g., panelists would have no reason to show increased ad recall if the panelists never actually looked at the ad).

In another example, the correlate measurement collector(s) 222 gather data that serves as a proxy for purchase behavior. For example, after administering one or more survey instruments to the panelists 202, 204, the MISA 212 may provide the panelists 202, 204 with a variety of coupons and/or discounts, at least one of which is associated with the target media 208. Whether the panelists 202, 204 select the coupon and/or discount associated with the target media 208 serves to indicate whether the panelists 202, 204 contemplate and/or plan on purchasing a product or service associated with the target media 208. In some examples, such purchase behavior data is correlate measurement data for comparison against the purchase consideration metric 108 and/or the purchase intent metric 110. In other examples, the implicit response data is correlated with actual sales data.

In some other examples, the correlate measurement collector(s) 222 include sensors to gather neuro-physiological data from the panelists 202, 204. The correlate measurement collector(s) 222 may include, for example, one or more electrode(s), camera(s) and/or other sensor(s) to gather any type(s) of neurological, physiological, and/or biological data, including, for example, brain activity based on functional magnetic resonance imaging (fMRI) data, electroencephalography (EEG) data, magnetoencephalography (MEG) data and/or optical imaging data. In some such examples, the neuro-physiological data may be gathered continuously, periodically and/or aperiodically while the panelists 202, 204 are exposed to the base media 206 (and the target media 208 for the test group panelists 202).

The example collected neuro-physiological response data may be indicative of one or more of alertness, engagement, attention, memory, and/or emotion of the panelists 202, 204 when being exposed to the base media 206 and/or target media 208. In the illustrated example, such measurements may serve as a correlate measurement to verify the implicit response data with respect to the mid-level effectiveness metrics such as the brand favorability metric 106.

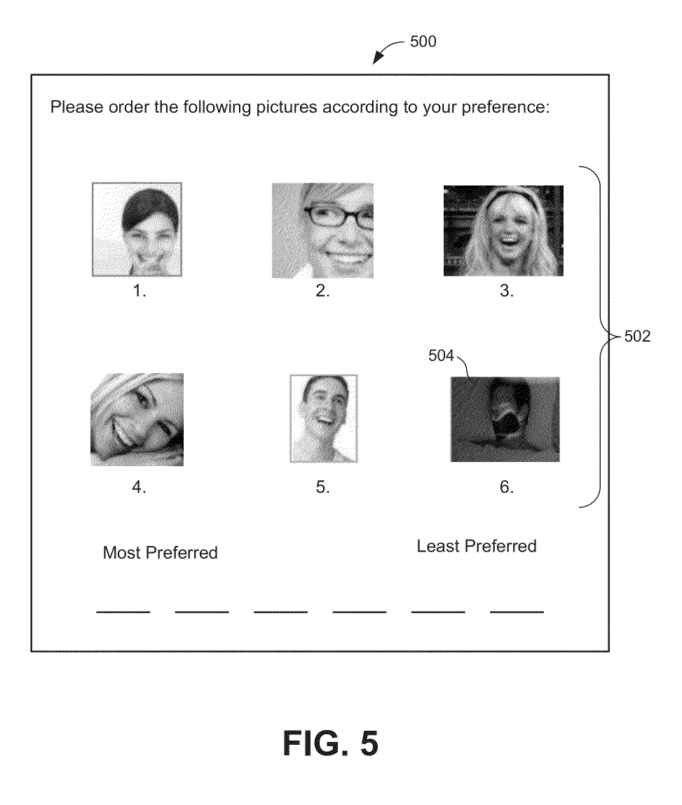

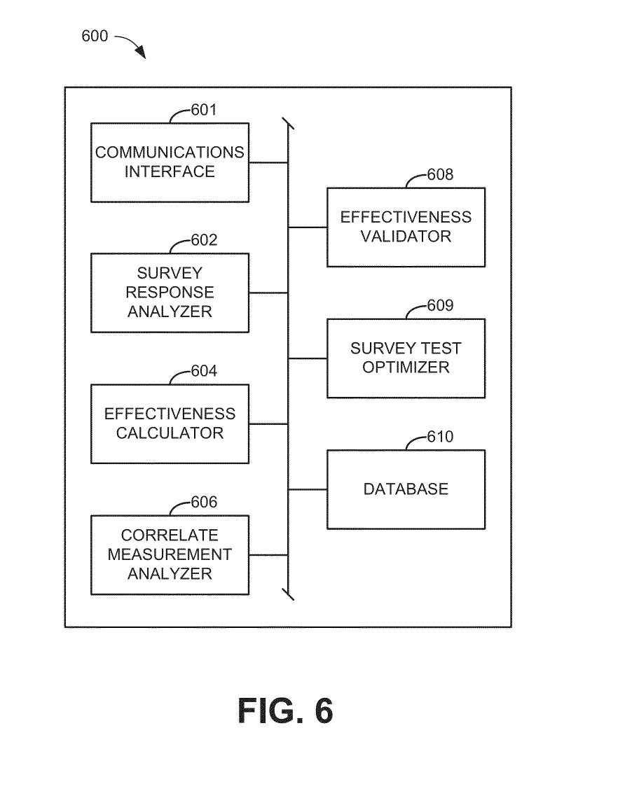

FIG. 6 is a schematic illustration of an example apparatus 600 constructed in accordance with the teachings of this disclosure to measure the explicit and implicit impact and/or effectiveness of media in the example system 200 of FIG. 2. In some examples, the apparatus 600 is implemented by the MIME 216. In some examples, the apparatus 600 is implemented by the MISA 212. In the illustrated example of FIG. 6, the example apparatus 600 includes an example communications interface 601, an example survey response analyzer 602, an example effectiveness calculator 604, an example correlate measurement analyzer 606, an example effectiveness validator 608, an example survey test optimizer 609, and an example database 610.

The example apparatus 600 of FIG. 6 is provided with the example communications interface 601 to provide the base media 206, the target media 208, and/or the survey instruments 214 to the panelists 202, 204. Additionally, the example communications interface 601 may gather survey response data from the panelists 202, 204 responding to the survey instruments 214. Furthermore, in some examples, the example communications interface 601 also gathers correlate measurement data via the correlate measurement collector(s) 222. In some examples, where the example apparatus 600 is implemented by the MIME 216 to analyze the survey response data and correlate measurement data, the communications interface enables the collection of such data via the MISA 212.

The example apparatus 600 of FIG. 6 is provided with the example survey response analyzer 602 to analyze the explicit and/or implicit response data obtained from the panelists 202, 204 while responding to the survey instruments 214 described in FIG. 2. In some examples, the operation of the survey response analyzer 602 depends on the type of survey instruments 214 used to survey the panelists 202, 204. For example, analyzing responses to explicit measures 218 (e.g., questionnaires, diaries, etc.) may involve identifying whether the response indicated a positive or negative reaction, any keywords used by the panelists 202, 204 in describing the panelists' 202, 204 thoughts, attitudes, and/or other reactions. In some examples, where the implicit measures 220 include an IAT or GNAT, the example survey response analyzer 602 analyzes (1) the response time for each item of each trial the panelists 202, 204 categorized and (2) whether the panelists' 202, 204 response was correct to determine an automatic or implicit bias (e.g., favorability or preference) the panelists 202, 204 may have for the tested categories of concepts and corresponding attributes. Similarly, for the other implicit measures 220 (e.g., priming, word completion, and sorting), the example survey response analyzer 602 may analyze the number and/or rate of correct responses as appropriate for each of the differing measures.

In some examples, the survey response analyzer 602 combines and/or integrates the responses from some or all panelists 202 in the test group and some or all panelists 204 in the control group. In such examples, the survey response analyzer 602 performs statistical analysis on the combined survey response data to assess an overall reaction of the test group panelists 202 and/or the control group panelists 204 to then extrapolate such analysis to a more general population. In some examples, the survey response analyzer 602 combines and/or integrates the response from some or all of the panelists 202, 204 in both the test group and the control group. For example, the priming implicit measure, as described above, includes separating the test group panelists 202 and the control group panelists 204 into two subgroups corresponding to those who are exposed to a primer and those who are not. In such an example, the survey response data may combine the responses of the primed panelists 202, 204 and the response of the non-primed panelists 202, 204 regardless of whether the panelists 202, 204 are in the control group or the test group.

The example effectiveness calculator 604 in the example apparatus 600 of FIG. 6 is provided to compare the analyzed survey response data from the test group panelists 202 with the analyzed survey response data from the control group panelists 204 to calculate an effectiveness or impact of the target media 208 based on the comparison. For example, faster response times, more correct responses, and/or more favorable responses by the test group panelists 202 than the responses of the control group panelists 204 indicates that the target media 208 had a positive impact on the test group panelists 202 and the target media 208 was, therefore, effective. In some examples, the analyzed survey response data is quantified so that the degree of difference in responses between the two groups may be assessed to calculate a degree of impact of the target media 208. Further, in some examples, the effectiveness calculator 604 compares the impact of the target media 208 across the various effectiveness metrics 102, 104, 106, 108, 110, 112 to assess what sort of impact the target media 208 had on the test panelists 202 and/or what metrics showed relatively less effectiveness.

In the illustrated example, the apparatus 600 is also provided with the example correlate measurement analyzer 606 to analyze the correlate measurement data obtained from the panelists 202, 204. In the example of FIG. 6, the example effectiveness validator 608 is provided to use the analyzed correlate measurement data to confirm and/or validate the survey response data by comparing the survey response data with the analyzed results of the correlate measurement data. For example, if the correlate measurement is implemented by eye tracking data, the example correlate measurement analyzer 606 analyzes the eye tracking data to determine what the panelists 202, 204 looked at while exposed to the base media 206 including whether the test group panelists 202 actually looked at the target media 208 and for how long. In some such examples, if the example correlate measurement analyzer 606 determines that a particular test group panelist 202 was not looking in the direction of the target media 208 when the target media 208 was presented, the example effectiveness validator 608 may identify the test group panelist 202 for removal from the effectiveness calculation disclosed above. In other examples, the example effectiveness validator 608 assigns a weight to the test group panelists 202 based on the survey response data corresponding to each of the test group panelists 202 with lower weights being assigned to the test group panelists 202 that did not directly look at the target media 208 and/or only viewed the target media 208 briefly.

In other examples, where neuro-physiological data is gathered from the panelists 202, 204, the example correlate measurement analyzer 606 analyzes the data to identify the effect of the media on the panelists 202, 204 during the panelists' 202, 204 exposure to the media. For example, if the neuro-physiological data includes EEG data, the example correlate measurement analyzer 606 may analyze the data to identify specific patterns, amplitudes, and/or frequencies of brain waves known to be indicative of neural activity associated with the emotion, attention, and/or memory of the panelists 202, 204. The example effectiveness validator 608 may then compare such data with the survey response data associated with a corresponding effectiveness metric (e.g., ad recall, brand favorability, etc.) to confirm and/or verify the assessment of the target media 208 based on the survey response data.

In other examples, if the correlate measurement data corresponds to purchase behavior and/or proxies for purchase behavior, the example correlate measurement analyzer 606 analyzes the purchase behavior data to determine whether the panelists 202, 204 have actually purchased products and/or services associated with the target media 208 and/or shown intent to make such purchases. Based on such an analysis the example effectiveness validator 608 then either confirms or invalidates the assessment of the effectiveness and/or impact of the target media 208 on the purchase consideration and/or purchase intent metrics 108, 110 of the example advertising funnel 100 of FIG. 1.

The example apparatus 600 of FIG. 6 is also provided with the example survey test optimizer 609 to improve (e.g., optimize) the survey test procedures associated with implementing the system 200 of FIG. 2. In the illustrated example, the example survey test optimizer enhances or improves the reliability of a calculated assessment of the impact or effectiveness of media and/or predictions of future consumer behavior based on the calculated effectiveness of the media with respect to different factors including one or more of the type of survey instrument(s) used, a latency period for administering the survey instrument(s), a format of the survey instrument(s), a wording of instructions and/or questions associated with the survey instrument(s), or a type of effectiveness metric being assessed. In some examples, the example survey test optimizer 609 changes one or more of the above factors between multiple surveys and then compares the calculated effectiveness of the media in each survey against each other with respect to actual purchase behavior of the panelists 202, 204.

The example database 610 of the illustrated example is provided to store the survey response data, the correlate measurement data, and/or the analyzed results from the example survey response analyzer 602, the effectiveness calculator 604, the example correlate measurement analyzer 606, and/or the effectiveness validator 608. Additionally, in some examples, the database 610 stores the base media 206, the target media 208, and/or the survey instruments 214 for display to the panelists 202, 204 via the example communications interface 601.

While an example manner of implementing the system 200 and the apparatus 600 have been illustrated in FIGS. 2 and 6, respectively, one or more of the elements, processes and/or devices illustrated in FIGS. 2 and/or 6 may be combined, divided, re-arranged, omitted, eliminated and/or implemented in any other way. Further, the example MISA 212, the example survey instruments 214, the example MIME 216, the example correlate measurement collector(s) 220, 222, the example communications interface 601, the example survey response analyzer 602, the example effectiveness calculator 604, the example correlate measurement analyzer 606, the example effectiveness validator 608, the example survey test optimizer 609, the example database 610, and/or, more generally, the example system 200 and/or apparatus 600 of FIG. 6 may be implemented by hardware, software, firmware and/or any combination of hardware, software and/or firmware. Thus, for example, any of the example MISA 212, the example survey instruments 214, the example MIME 216, the example correlate measurement collector(s) 220, 222, the example communications interface 601, the example survey response analyzer 602, the example effectiveness calculator 604, the example correlate measurement analyzer 606, the example effectiveness validator 608, the example survey test optimizer 609, the example database 610, and/or, more generally, the example system 200 and/or apparatus 600 of FIG. 6 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example MISA 212, the example survey instruments 214, the example MIME 216, the example correlate measurement collector(s) 220, 222, the example communications interface 601, the example survey response analyzer 602, the example effectiveness calculator 604, the example correlate measurement analyzer 606, the example effectiveness validator 608, the example survey test optimizer 609, and/or the example database 610 are hereby expressly defined to include a tangible computer readable storage medium such as a memory, DVD, CD, or BluRay storing the software and/or firmware. Further still, the example system 200 of FIG. 2 and the example apparatus 600 of FIG. 6 may include one or more elements, processes and/or devices in addition to, or instead of, those illustrated in FIGS. 2 and 6, and/or may include more than one of any or all of the illustrated elements, processes and/or devices.

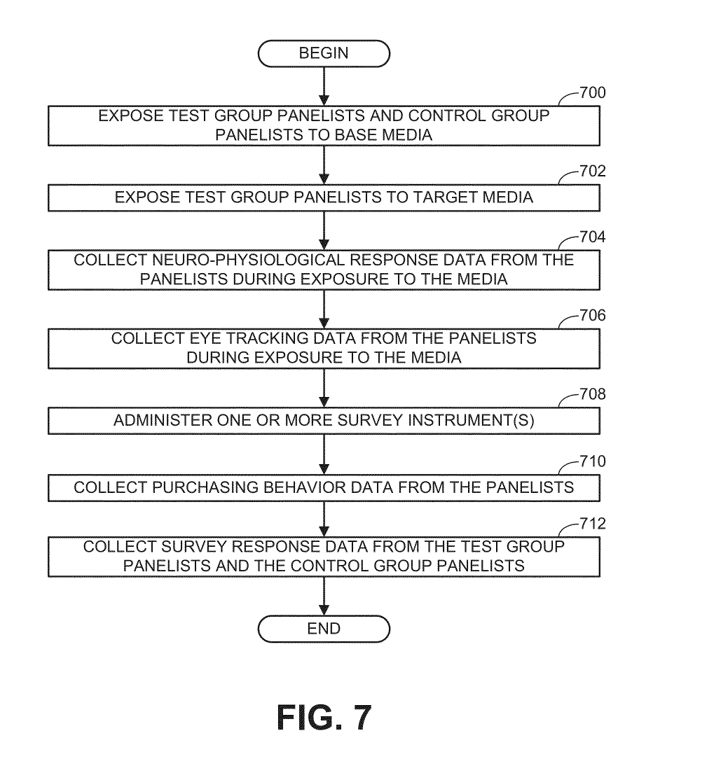

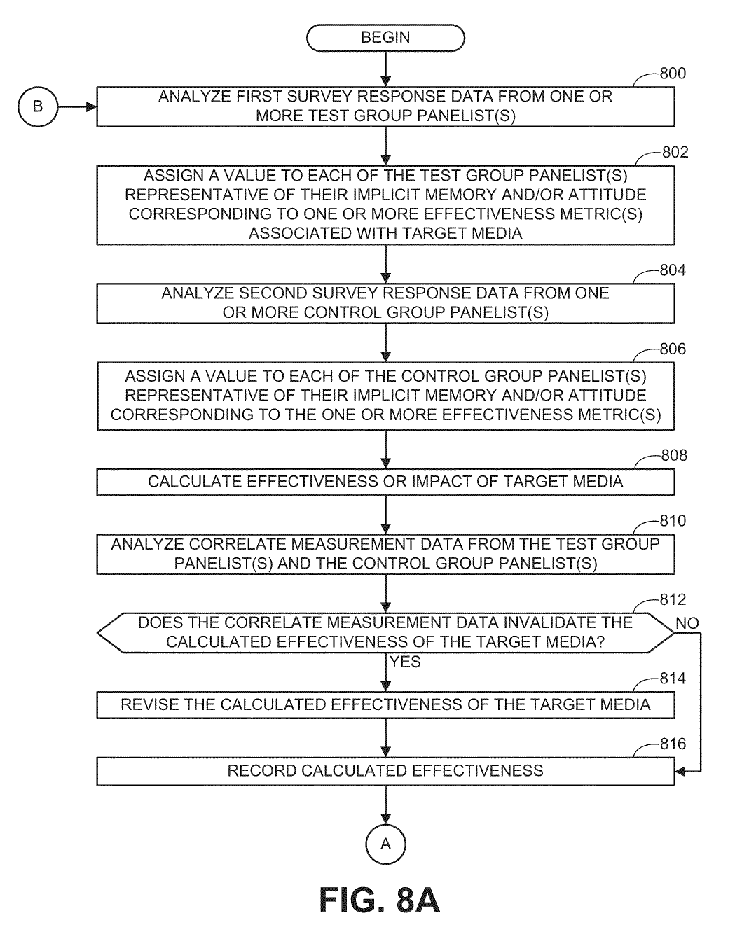

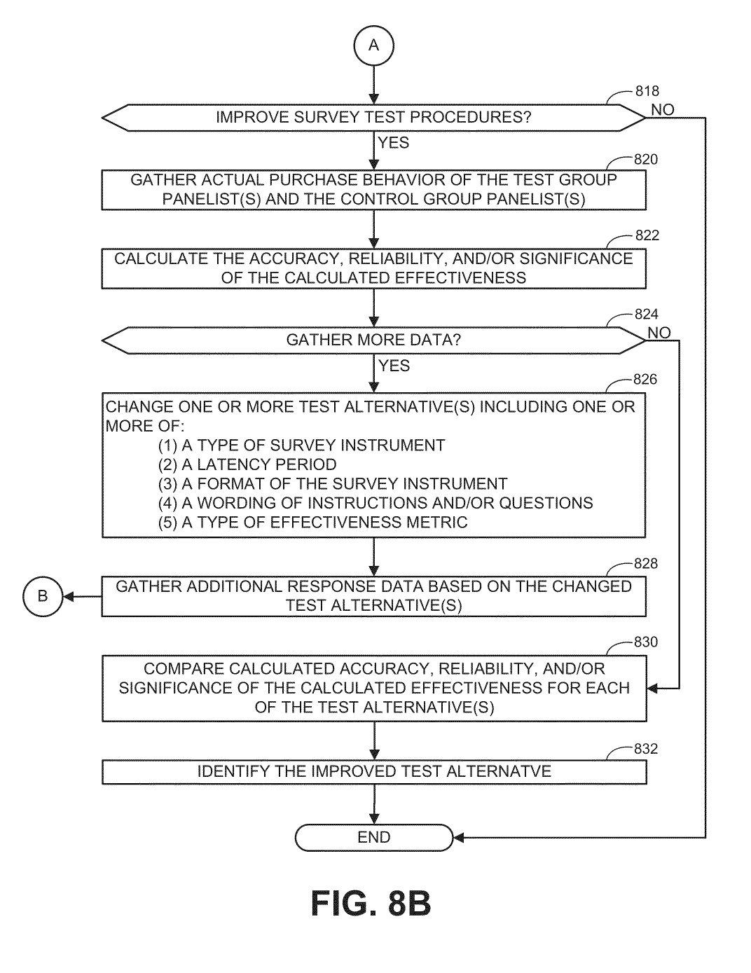

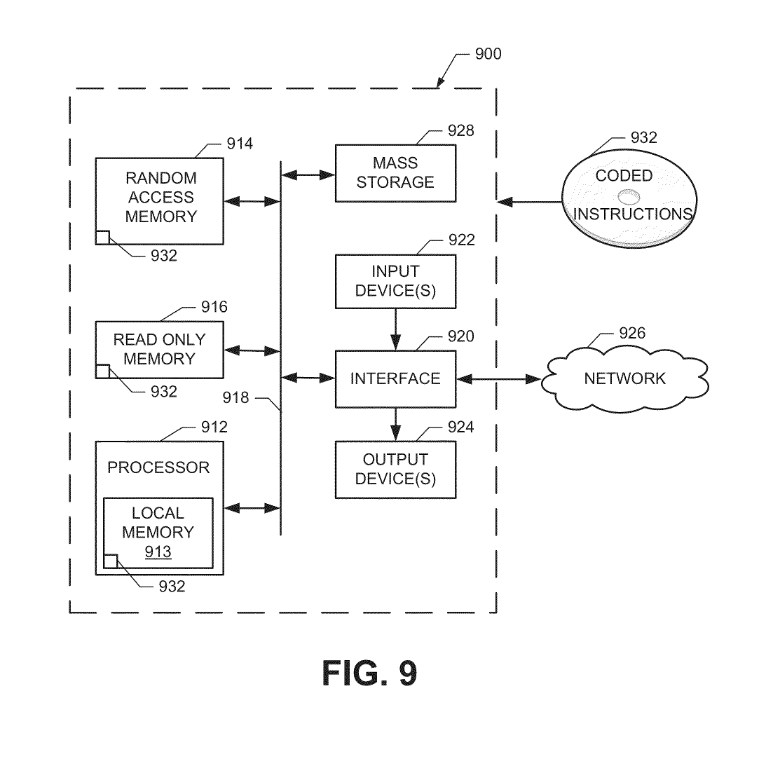

Flowcharts representative of example machine readable instructions which may be executed to implement the system 200 of FIG. 2 and/or the apparatus 600 of FIG. 6 are shown in FIGS. 7, 8A, and 8B. In these examples, the machine readable instructions comprise a program for execution by a processor such as the processor 912 shown in the example processor platform 900 discussed below in connection with FIG. 9. The program may be embodied in software stored on a tangible computer readable storage medium such as a CD-ROM, a floppy disk, a hard drive, a digital versatile disk (DVD), a BluRay disk, or a memory associated with the processor 912, but the entire program and/or parts thereof could alternatively be executed by a device other than the processor 912 and/or embodied in firmware or dedicated hardware. Further, although the example program is described with reference to the flowcharts illustrated in FIGS. 7, 8A, and 8B many other methods of implementing the example system 200 and example apparatus 600 may alternatively be used. For example, the order of execution of the blocks may be changed, and/or some of the blocks described may be changed, eliminated, or combined.

As mentioned above, the example processes of FIGS. 7, 8A, and 8B may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other physical storage device or storage disk in which information is stored for any duration (e.g., for extended time periods, permanently, brief instances, for temporarily buffering, and/or for caching of the information). As used herein, the term tangible computer readable storage medium is expressly defined to include any type of computer readable storage device or storage disk and to exclude propagating signals. Additionally or alternatively, the example processes of FIGS. 7, 8A, and 8B may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 7 is a flowchart representative of example computer readable instructions which may be executed to gather the survey response data and the correlate measurement data in the example system of FIG. 2, and/or to implement the example apparatus of FIG. 6. The illustrated example begins when the example communications interface 601 exposes one or more test group panelist(s) and one or more control group panelist(s) to base media (block 700) (e.g., via the media presentation devices 210 of FIG. 2). The example communications interface 601 also exposes the test group panelist(s) to target media (block 702) (e.g., via the media presentation devices 210 of FIG. 2).

In some examples, the example instructions also cause the communications interface 601 to collect neuro-physiological response data from the panelists during exposure to the media (block 704) (e.g., via the correlate measurement collector(s) 222 of FIG. 2). The example communications interface 601 also collects eye-tracking data from the panelists during exposure to the media (block 706) (e.g., via the correlate measurement collector(s) 222 of FIG. 2). In some examples the communications interface 601 collects neuro-physiological data (block 704) and eye-tracking data (block 706) only from the test group panelist(s). In other examples, such data is collected from both the test group panelist(s) and the control group panelist(s).

The example communications interface 601 further collects purchasing behavior data from the panelists (block 708). In some examples, the purchasing behavior data is based on proxies for actual purchasing behavior such as the selection of coupons and/or discounts made by the panelists 202, 204 after exposure to the media. Additionally, the communications interface 601 collects survey response data from the test group panelists 202 and the control group panelists 204 (block 712) (e.g., in response to the survey instruments 214 of FIG. 2) at which point the example of FIG. 7 ends.

The example flowchart of FIGS. 8A and 8B is representative of example computer readable instructions which may be executed to assess an effectiveness or impact of media of the panelists 202, 204 in the example system 200 of FIG. 2, and/or to implement the example apparatus of FIG. 6. The illustrated example begins with the survey response analyzer 602 of FIG. 6 analyzing first survey response data from one or more test group panelist(s) (block 800). In the example of FIGS. 8A and 8B, the first survey response data is based on responses from one or more implicit and/or explicit measures from the test group panelist(s) following exposure to a base media and a target media (e.g., the advertising or entertainment material to be assessed for effectiveness and/or impact).

The analysis involved in the illustrated example that is performed by the survey response analyzer 602 depends on the type of survey response data being analyzed. For example, if the first survey response data includes a response to an explicit measure (e.g., a survey question), the survey response analyzer 602 identifies whether the response indicates a positive or negative reaction, and/or any keywords used by the test group panelist(s) in describing the thoughts, attitudes, and/or other reactions of the test group panelist(s). In other examples, where the first survey response data includes a response to an implicit measure (e.g., IAT, GNAT, word completion, etc.), the survey response analyzer 602 analyzes the response times, the nature of response, the speed of completion of the measure, the number of correct or incorrect responses, and so forth, to obtain an indication of the implicit memories and/or attitudes of the test group panelist(s) with respect to the target media. In some examples, where there are multiple test group panelist(s), the survey response analyzer 602 may aggregate or combine the first survey response data and analyze the same for any trends, themes, or other common characteristics among responses across the test group panelist(s).

After analyzing the first survey response data from the test group panelist(s) (block 800), the survey response analyzer 602 assigns a value to each of the test group panelist(s) representative of the panelists' implicit memory and/or attitude corresponding to one or more effectiveness metric(s) associated with the target media (block 802). In some examples, the effectiveness metrics correspond to one or more of an ad recall, a brand awareness, a product awareness, a brand favorability, a product favorability, a brand preference, a product preference, a brand purchase consideration, a product purchase consideration, a brand purchase intent, a product purchase intent, a brand recommendation, and/or a product recommendation. In some examples, the implicit memory and/or attitude for each panelist is to be analyzed relative to the implicit memory and/or attitudes of one or more of the other panelists. In such examples, different methods of quantifying and/or assigning a specific value to the implicit memory and/or attitude of the test group panelist(s) may be used.

In some examples, the first survey response data from multiple survey instruments correspond to the same effectiveness metric. In some such examples, the analyzed results of the different survey responses are combined into an average value representative of the implicit memory and/or attitude of the test group panelist(s). In some examples, the different survey instruments are given different weights based on the reliability of the survey instruments in assessing the implicit memory and/or attitudes of the test group panelist(s) and/or predicting the behavior of the panelist(s) as a result of the calculated implicit memory and/or attitudes. In some examples, the quantified value corresponding to each effectiveness metric may be combined into an overall figure representative of a generic implicit memory and/or attitude of the test group panelist(s).

In the example of FIGS. 8A and 8B, the survey response analyzer 602 analyzes second survey response data from one or more control group panelist(s) (block 804). In the illustrated example, the second survey response data is based on responses from one or more implicit and/or explicit measures from the control group panelist(s) following exposure to a base media. The difference between the first and second survey response data is that the control group panelist(s) were not exposed to the target media like the test group panelist(s). The survey response analyzer 602 analyzes the second survey response data in conjunction with or simultaneously to the analysis of the first survey response data disclosed above at block 800 to obtain an indication of any preexisting implicit memories and/or attitudes of the control group panelist(s) with respect to the target media, even though the control group panelist(s) were not exposed to the target media.

The survey response analyzer 602 assigns a value to each of the control group panelist(s) representative of the panelists' implicit memory and/or attitude corresponding to the one or more effectiveness metrics (block 806) (using, for example, the survey response analyzer 602). The quantification or valuation of the implicit memory and/or attitude of the control group panelist(s) is similar to or the same as the process for the test group panelist(s) disclosed above at block 802.

The example effectiveness calculator 604 in the example of FIGS. 8A and 8B then calculates an effectiveness or impact of the target media (block 808). In the example program, the effectiveness of the target media is calculated based on the amount of lift in the implicit memory and/or attitude of the test group panelist(s) when compared against the implicit memory and/or attitude of the control group panelist(s). That is, the effectiveness of the target media may be expressed as the assigned value of the implicit memory and/or attitude of the test group panelist(s) discounted by the assigned value of the implicit memory and/or attitude of the control group panelist(s). In some examples, the effectiveness or impact of the target media is determined separately for each of the relevant effectiveness metrics. For example, the impact of the target media on implicit brand favorability corresponds to the implicit brand favorability of the test group panelist(s) subtracted by the implicit brand favorability of the control group panelist(s). Additionally or alternatively, in other examples, the effectiveness calculator 604 combines the differing metrics to calculate an overall or generic effectiveness of impact of the target media.

The illustrated example, the correlate measurement analyzer 606 of FIG. 6 analyzes correlate measurement data from the test group panelist(s) and the control group panelist(s) (block 810). The correlate measurement data provides independent or secondary measurement(s) to either verify or invalidate the analysis of the survey response data and/or the resulting effectiveness calculations. Specifically, the correlate measurement data may include at least one of eye-tracking data, neuro-physiological response data, or purchase behavior data. In some examples, the correlate measurement analyzer 606 analyzes eye-tracking data to determine whether and/or for how long the test group panelist(s) actually looked at the target media (e.g., an online banner advertisement embedded on a website). In some examples, the correlate measurement analyzer 606 analyzes neuro-physiological response data to identify specific patterns, amplitudes, and/or frequencies of brain waves indicative of neural activity associated with the emotion, attention, and/or memory of the panelists. In other examples, the correlate measurement analyzer 606 analyzes the purchase behavior data (based on actual transactions and/or proxies of actually purchase behavior) to identify whether and/or when the test group panelist(s) and/or the control group panelist(s) purchased goods or services associated with the target media.

In the example of FIGS. 8A and 8B, based on the analysis of the correlate measurement data (block 810), the effectiveness validator 608 of FIG. 6 determines whether the correlate measurement data invalidates the calculated effectiveness of the target media (block 812). The calculated effectiveness of the target media is invalidated if the correlate measurement data indicates any unreliability in the first or second survey response data. If it is determined that the correlate measurement data does not invalidate the calculated effectiveness of the target media (block 812), the example program of FIG. 8A records the calculated effectiveness (block 816). If the effectiveness validator 608 determines that the correlate measurement data does invalidate the calculated effectiveness of the target media (block 812), control advances to block 814 where the calculated effectiveness of the target media is revised (block 814). For example, the effectiveness validator 608 may determine that the survey response data obtained from one or more of the test group panelist(s) is not reliable (i.e., invalidates the calculated effectiveness of the target media (block 812)) because the identified test group panelist(s) did not actually look at the target media, did not look at the target media for at least a threshold time period and/or has brain wave patterns that indicate increased waves associated with sleep or a lack of engagement and/or decreased waves associated with focus attention. Accordingly, in some such examples, the effectiveness validator 608 identifies the survey response data from the corresponding test group panelist(s) for exclusion from the calculation of the effectiveness of the target media. In other examples, the effectiveness validator 608 identifies the survey response data from the corresponding test group panelist(s) to be given less weight in the calculation of the effectiveness or impact of the target media. Based on the survey response data to be excluded and/or otherwise adjusted, the effectiveness calculator 604 revises the calculated effectiveness or impact of the target media as disclosed above at block 808. Once the calculated effectiveness of the target media is revised (block 812), the example effectiveness calculator 604 records the calculated effectiveness in the database 610 (block 816).

Continuing on to FIG. 8B of the illustrated example, the example survey test optimizer 609 determines whether to improve the survey test procedures (block 818). If the survey test optimizer 609 determines not to improve the survey test procedures, the example of FIGS. 8A and 8B ends. In some examples, the survey test optimizer 609 determines not to improve the test procedure because the test has already been improved (e.g., optimized) for the use in which the test is being implemented.

If the survey test optimizer 609 determines that the survey test procedure is to be improved (block 818), the example communications interface 601 gathers actual purchase behavior of the test group panelist(s) and the control group panelist(s) (block 820) (using, for example, the communications interface 601). In the illustrated example, the effectiveness validator 608 calculates an accuracy, reliability, and/or significance of the calculated effectiveness (block 822). In some examples, the accuracy of the calculated effectiveness is determined based on how predictive the calculated effectiveness is of actual purchase behavior based on a comparison with such. In some such examples, the accuracy is dependent on the type of survey instrument used (e.g., explicit measures versus implicit measures, IAT versus word completion test) and/or the format of the survey instrument (e.g., direct questions versus a game-like format). Also, in some examples, the accuracy is dependent on the terms, phrases, attributes and/or categories used in the survey instruments. In some examples, the significance of the calculated effectiveness is based on an amount of lift associated with the corresponding effectiveness metric relative to the lift corresponding to other effectiveness metrics. In some examples, the reliability is based on a level of variation between the first survey response data and the second survey response data (e.g., to obtain statistically significant results). In yet other examples, the accuracy, reliability and/or significance of the calculated effectiveness is based on a latency period prior to administering the survey instrument.

In the example illustrated in FIG. 8B the survey test optimizer 609 determines whether to gather more data (block 824). In some examples, the survey test optimizer 609 determines to gather more data because additional data may be needed to compare the calculated effectiveness of multiple surveys implemented using different test procedures, including for example, where some testing parameters have not been assessed. In some examples, the survey test optimizer 609 changes one or more test alternative(s) including one or more of (1) a type of a survey instrument, (2) a latency period for the survey instrument, (3) a format of the survey instrument, (4) a wording of instructions, questions and/or terms associated with the survey instrument(s), and (5) a type of effectiveness metric being assessed (block 826). In some examples, changing the type of survey instrument involves changing from an explicit measure to an implicit measure. In some examples, the change may be based on different types of explicit measures (e.g., multiple choice to short answer questions) or implicit measures (e.g., sorting to GNAT). In some examples, the range of latency period may be changed between a time period immediately following exposure to the media to 24 hours or more after exposure to the media. In some examples, changing the format of the survey includes making the survey instruments more game like (e.g., adding a point accumulation scheme) and/or otherwise changing the flow and/or appearance of the survey instruments including, for example, a number of word(s) included in a word completion test, a type of an item (e.g., words, phrases, logos, pictures, symbols etc. used in any of the survey instruments disclosed herein). In some examples, the wording of instructions and/or questions associated with the survey instruments is varied to avoid ambiguities and/or creating bias in the panelists. In some examples, the effectiveness metric being assess may be varied by changing the survey instrument used and/or by changing the questions and/or instructions of the survey instrument as disclosed above.

In some examples, the example communications interface 601 gathers additional response data based on the changed test alternative(s) (block 828). In some examples, administering the changed test alternative(s) and/or gathering the resulting response data corresponds to the example disclosed in connection with FIG. 7. With additional data gathered (block 828), control returns to block 800 (FIG. 8A), and the example apparatus 600 proceeds through block 822 (FIG. 8B) to analyze the data to calculate an effectiveness of the target media and an accuracy, reliability, and/or significance of the calculated effectiveness. The example survey test optimizer 609 then again determines whether to gather more data (block 824). If the example survey test optimizer 609 determines to gather additional data (block 824), the example apparatus 600 proceeds through another iteration of the illustrated example as disclosed above. However, if the example survey test optimizer 609 determines not to gather additional data (block 824), the example survey test optimizer 609 compares the calculated accuracy, reliability, and/or significance of the calculated effectiveness for each of the test alternative(s) (block 830). Based on the comparison, the survey test optimizer 609 identifies the improved test alternative (block 832). The improved test alternative refers to the better (e.g., enhanced, likely to provide an increased amount of valid data, etc.) of two alternatives with respect to one or more factors including one or more types of survey instrument(s), one or more types of metrics, one or more methods of evaluating the effectiveness metrics (e.g., a level of variation in response of the panelists, an amount of lift, or a degree of correlation with external variables), the format of the survey instruments, the wording of instructions and or questions associated with the survey instruments, the latency period before conducting the survey instruments. Thus, depending upon the factors used as the basis for optimization, one test alternative may be identified as more optimal (i.e., better) test alternative than another but when a different factor is being used, the other alternative may be identified as the optimal (i.e., better) test alternative. After identifying the improved test alternative, the example of FIGS. 8B and 8B ends.

FIG. 9 is a schematic illustration of an example processor platform 900 that may be used and/or programmed to execute any of the example machine readable instructions of FIGS. 7, 8A, and 8B to implement the example apparatus 600 of FIG. 6. The processor platform 900 of the instant example includes a processor 912. For example, the processor 912 can be implemented by one or more microprocessors or controllers from any desired family or manufacturer.

The processor 912 includes a local memory 913 (e.g., a cache) and is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914 and 916 is controlled by a memory controller.

The processor platform 900 also includes an interface circuit 920. The interface circuit 920 may be implemented by any type of interface standard, such as an Ethernet interface, a universal serial bus (USB), and/or a PCI express interface. One or more input devices 922 are connected to the interface circuit 920. The input device(s) 922 permit a user to enter data and commands into the processor 912. The input device(s) can be implemented by, for example, a keyboard, a mouse, a touchscreen, a track-pad, a trackball, isopoint and/or a voice recognition system. One or more output devices 924 are also connected to the interface circuit 920. The output devices 924 can be implemented, for example, by display devices (e.g., a liquid crystal display, a cathode ray tube display (CRT), a printer and/or speakers). The interface circuit 920, thus, typically includes a graphics driver card.

The interface circuit 920 also includes a communication device such as a modem or network interface card to facilitate exchange of data with external computers via a network 926 (e.g., an Ethernet connection, a digital subscriber line (DSL), a telephone line, coaxial cable, a cellular telephone system, etc.).

The processor platform 900 also includes one or more mass storage devices 928 for storing software and data. Examples of such mass storage devices 928 include floppy disk drives, hard drive disks, compact disk drives and digital versatile disk (DVD) drives.

Coded instructions 932 to implement the example processes of FIGS. 7, 8A, 8B may be stored in the mass storage device 928, in the volatile memory 914, in the non-volatile memory 916, and/or on a removable storage medium such as a CD or DVD.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method comprising:
analyzing first survey response data obtained from a first control group panelist responding to a first survey instrument after exposure to first media, the first survey instrument comprising an implicit measure and the first survey response data comprising first implicit response data;
analyzing second survey response data obtained from a first test group panelist responding to the first survey instrument after exposure to second media, the second survey response data comprising second implicit response data, the second media comprising elements of the first media and target advertising or entertainment material not included in the first media; and
assessing a first effectiveness of the target advertising or entertainment material based on the first and second implicit response data.

2. The method of claim 1, wherein the first and second implicit response data are associated with at least one of an ad recall, a brand awareness, a product awareness, a brand favorability, a product favorability, a brand preference, a product preference, a brand purchase consideration, a product purchase consideration, a brand purchase intent, a product purchase intent, a brand recommendation, or a product recommendation.

3. The method of claim 2, wherein assessing the first effectiveness of the target advertising or entertainment material is based on a difference between a first value of the media effectiveness metric associated with the control group panelist and a second value of the media effectiveness metric associated with the test group panelist.

4. The method of claim 2, further comprising:
analyzing correlate measurement data gathered from the first test group panelist; and
validating the implicit response data based on the correlate measurement data.

5. The method of claim 4, wherein the correlate measurement data comprises at least one of eye-tracking data, neuro-physiological data, or purchase behavior data of the test group panelist.

6-7. (canceled)

8. The method of claim 1, wherein the implicit measure comprises an implicit association test.

9. The method of claim 8, wherein a first concept in a complementary pair associated with the implicit association test corresponds to a first product or brand and a second concept in the complementary pair is associated with a competing product or brand, the first product or brand being related to the target advertising or entertainment material.

10. The method of claim 1, wherein the implicit measure comprises a go-no-go association test.

11. (canceled)

12. The method of claim 1, wherein the implicit measure comprises a sorting test.

13. The method of claim 12, wherein the sorting test comprises a plurality of items to sort, the plurality of items includes a first item associated with the target advertising or entertainment material, and the plurality of items includes at least one of a picture, a word, or a logo.

14. The method of claim 12, wherein the sorting test requests the first test group panelist and the first control group panelist to sort the plurality of items based on at least one of preference or recognition.

15. The method of claim 1, wherein the implicit measure comprises a word completion test.

16. The method of claim 15, wherein the word completion test requests a test taker to fill in a missing letter or a missing word related to at least one of (1) a target word or phrase associated with the target advertising or entertainment material or (2) a distracter word or phrase unrelated to the target advertising or entertainment material.

17. The method of claim 1, wherein the implicit measure comprises priming.

18. The method of claim 17, wherein the priming comprises exposing the first control group panelist and the first test group panelist to a primer associated with the target advertising or entertainment material before the first control group panelist and the first test group panelist are to respond to a second survey instrument.

19. (canceled)

20. The method of claim 1, wherein the first survey instrument is in a game format.

21. The method of claim 20, wherein the game format comprises at least one of awarding a point for a completed response, awarding a point for a correct response, deducting a point for an incorrect response, or awarding a point for a speed of response.

22-25. (canceled)

26. A tangible machine readable storage medium comprising instructions, which when executed, cause a machine to at least:
analyze first survey response data obtained from a first control group panelist responding to a first survey instrument after exposure to first media, the first survey instrument comprising an implicit measure and the first survey response data comprising first implicit response data;
analyze second survey response data obtained from a first test group panelist responding to the first survey instrument after exposure to second media, the second survey response data comprising second implicit response data, the second media comprising elements of the first media and target advertising or entertainment material not included in the first media; and
assess a first effectiveness of the target advertising or entertainment material based on the first and second implicit response data.

27. The storage medium of claim 26, wherein the first and second implicit response data correspond to a media effectiveness metric, the media effectiveness metric associated with a measure of at least one of an ad recall, a brand awareness, a product awareness, a brand favorability, a product favorability, a brand preference, or a product preference, a brand purchase consideration, a product purchase consideration, a brand purchase intent, a product purchase intent, a brand recommendation, a product recommendation.

28-32. (canceled)

33. The storage medium of claim 26, wherein the implicit measure comprises an implicit association test.

34. (canceled)

35. The storage medium of claim 26, wherein the implicit measure comprises a go-no-go association test.

36. (canceled)

37. The storage medium of claim 26, wherein the implicit measure comprises a sorting test.

38-39. (canceled)

40. The storage medium of claim 26, wherein the implicit measure comprises a word completion test.

41. (canceled)

42. The storage medium of claim 26, wherein the implicit measure comprises priming.

43-50. (canceled)

51. An apparatus, comprising:
a survey response analyzer to:
analyze first survey response data obtained from a first control group panelist responding to a first survey instrument after exposure to first media, the first survey instrument comprising an implicit measure and the first survey response data comprising first implicit response data; and
analyze second survey response data obtained from a first test group panelist responding to the first survey instrument after exposure to second media, the second survey response data comprising second implicit response data, the second media comprising elements of the first media and target advertising or entertainment material not included in the first media; and
an effectiveness calculator to assess a first effectiveness of the target advertising or entertainment material based on the first and second implicit response data.

52-57. (canceled)

58. The apparatus of claim 51, wherein the implicit measure comprises an implicit association test.

59. (canceled)

60. The apparatus of claim 51, wherein the implicit measure comprises a go-no-go association test.

61. (canceled)

62. The apparatus of claim 51, wherein the implicit measure comprises a sorting test.

63-64. (canceled)

65. The apparatus of claim 51, wherein the implicit measure comprises a word completion test.

66. (canceled)

67. The apparatus of claim 51, wherein the implicit measure comprises priming.

68-75. (canceled)
